(19) United States
(12) Patent Application Publication
(10) Pub. No.: US 2023/0202006 A1
(43) Pub. Date: Jun. 29, 2023

(54) MAGNETICALLY LOCKING MECHANISM OF A TORQUE WRENCH

(71) Applicant: Shanghai UB Machinery Co, Ltd., Shanghai (CN)

(72) Inventors: Jan Slawomir STASIEK, Shanghai (CN); Erying YUE, Shanghai (CN)

(21) Appl. No.: 17/743,528

(22) Filed: May 13, 2022

(30) Foreign Application Priority Data
Dec. 27, 2021 (CN) 202111616845. X

(51) Int. Cl. B25B 23/142

(52) U.S. Cl. CPC B25B 23/1427

(57) ABSTRACT

Disclosed in the present application is a magnetically locking mechanism of a torque wrench. It includes a main tube and an adjusting tube. One end of the adjusting tube is coaxially sleeved at the tail end of the main tube, and the other end of the adjusting tube is connected to an adjusting screw. A locking sheath is sleeved outside the adjusting tube at an end close to a head end of the main tube. An inner wall of one end of the locking sheath close to the head of the main tube is formed with a cam surface. A hole is opened in the adjusting tube at a position corresponding to the cam surface. An outer wall of the main tube is provided with a plurality of long groove along an axis of the main tube.

### CROSS-REFERENCE TO RELATED APPLICATION

The present application is based on and claims the priority benefits of China application No. 202111616845.X, filed on Dec. 27, 2021. The entirety of China application No. 202111616845.X is hereby incorporated by reference herein and made a part of this specification.

### TECHNICAL FIELD

The present application relates to the technical field of a torque wrench, and particularly to a magnetically locking mechanism of a torque wrench.

### BACKGROUND ART

A torque wrench, also known as a torque-adjustable wrench, is a kind of common wrench. The torque wrench can adjust the torque according to the tightening degree between bolts and nuts, so that the bolts and nuts can be tightened with a high precision. Therefore, the torque wrench is especially suitable for the assembling of high-precision equipment.

Referring to FIG. 3, in a related technology, a torque adjusting mechanism of a torque wrench includes a main tube 1 and an adjusting spring 11 coaxially arranged in the middle of the main tube 1. One end of the main tube 1 close to a plug-in unit (i.e. the plug-in unit having a connecting bolt or nut port) is called the head, and one end of the main tube 1 away from the head is called the tail end. The tail end of the main tube 1 is coaxially arranged with a nut 12, the nut 12 is threadedly connected with an adjusting screw 13, and one end of the adjusting screw 13 close to the adjusting spring 11 extends through the nut 12 and abuts against the adjusting spring 11. An adjusting tube 2 is arranged at the tail end of the main tube 1, one end of the adjusting tube 2 is coaxially sleeved onto the tail end of the main tube 1, and one end of the adjusting tube 2 away from the main tube 1 is fixedly connected with one end of the adjusting screw 13 away from the adjusting spring 11. An abutting surface is provided at one side of the adjusting tube 2 positioning at the tail end of the main tube 1. A locking sheath 3 is sleeved onto one end of the adjusting tube 2 close to the head of the main tube 1. A locking spring is abutted between the locking sheath 3 and the abutting surface. A cam surface 311 is provided at of the inner wall of the end of the locking sheath 3 away from the butting surface. A hole 23 is provided at the adjusting tube 2 close to the cam surface 311, and an outer wall of the main tube 1 is arranged with a long groove 42 along the axis of the main tube 1. Further, a plurality of long grooves 42 are arranged around the axis of the main tube 1. A jumping bead 41 is inserted in the hole 23. One side of the jumping bead 41 is inserted in the long groove 42 and abuts against the bottom wall of the long groove 42, and the other side abuts against the cam surface 311.

In the above related technologies, the locking sheath is pulled to adjust the torque of the torque wrench, and the torque cannot be adjusted after loosening the locking sheath. Further, if the adjusting range is relatively large, the locking sheath has to be pulled for a long time, which has poor adjustment convenience and in turn has a room for improvement.

### SUMMARY

In view of the poor convenience in torque adjustment of a torque wrench in related technologies, the present application provides a magnetically locking mechanism of a torque wrench.

A magnetically locking mechanism of a torque wrench provided in the present application adopts the following technical solution.

A magnetically locking mechanism of a torque wrench includes a main tube and an adjusting tube. One end of the adjusting tube is coaxially sleeved onto a tail end of the main tube, and the other end of the adjusting tube is connected to an adjusting screw. A locking sheath is sleeved outside the adjusting tube at an end close to a head end of the main tube. An inner wall of one end of the locking sheath close to the head of the main tube is formed with a cam surface. A hole is opened in the adjusting tube at a position corresponding to the cam surface. An outer wall of the main tube is provided with a long groove along an axis of the main tube, and a plurality of the long grooves are provided along the axis of the main tube. A jumping bead is inserted in the hole, with one side entering the long groove and abutting against a bottom wall of the long groove, and the other side abutting against the cam surface. A fixing part for fixing a position of the locking sheath after sliding on the adjusting tube is arranged between the locking sheath and the adjusting tube.

In the above technical solution, to adjust the torque of the torque wrench, firstly, the locking sheath is pulled to reduce a force applied to the jumping bead by the cam surface, and then the locking sheath and the adjusting tube are locked by the fixing part, after which the adjusting tube can be rotated freely to adjust the torque of the torque wrench. When the adjustment is completed, the fixing part can be operated to unlock the locking sheath and the adjusting tube. At this time, the locking sheath is pushed to force the cam surface to press the jumping bead again, so that the jumping bead is stuck in the long groove to limit the rotation of the adjusting tube. At the same time, the fixing part can lock the locking sheath and the adjusting tube to ensure the stability of the locking sheath. This facilitates adjusting the torque of the torque wrench.

In some embodiments, the fixing part is a magnetic ring, and the locking sheath is a magnetizable part. A reserving ring groove is coaxially provided in the middle of an inner wall of the locking sheath. The magnetic ring is coaxially fixed and sleeved onto the adjusting tube, and positioned in the reserving ring groove, and a thickness of the magnetic ring along its axial direction is less than a width of the reserving ring groove.

In the above technical solution, on one hand, the magnetic ring is used to adsorb the locking sheath to fix the locking sheath and the adjusting tube, so as to further facilitate adjusting the torque of the torque wrench. On the other hand, due to the providing of the reserving ring groove, when the magnetic ring is positioned at the edges of both sides in a width direction of the reserving ring groove, the magnetic ring can be adsorbed to two adjacent side walls of the reserving ring groove at the same time to provide a more stable connection between the locking sheath and the adjusting tube. In addition, the cooperation between the magnetic ring and the reserving ring groove can also limit the sliding range of the locking sheath, and the locking sheath can also cover and hide the magnetic ring.

In some embodiments, the locking sheath includes a front ring section and a rear ring section provided along an axis of the locking sheath, the cam surface is provided on an inner wall of the front ring section, the front ring section and the rear ring section are detachably and fixedly connected with each other, and a reserving half-groove is provided in ends of the front ring section and the rear ring section close to each other, respectively, and the reserving ring grooves comprises two reserving half-grooves.

In the above technical solution, the locking sheath is divided into the front ring section and the rear ring section to facilitate the installation of the magnetic ring.

In some embodiments, the magnetic ring is provided with a locking screw from outside to inside, and one end of the locking screw is screwed into the adjusting tube.

In the above technical solution, the magnetic ring is locked and fixed via the locking bolt on the adjusting tube to ensure the stability of the magnetic ring.

In some embodiments, an outer wall of one end of the adjusting tube close to the head of the main tube is provided with scale lines at intervals around the axis of the adjusting tube, and an outer wall of the main tube is provided with a reference line.

In the above technical solution, the use of the scale line in combination with the reference line will further improve the convenience and the accuracy in adjusting the torque of the torque wrench.

In some embodiments, a handle is fixedly sleeved onto the adjusting tube at an end away from the head end of the main tube, a step-shaped ring groove is provided in an inner wall of the handle close to one end of the locking sheath, and a compression spring is provided between the locking sheath and the step surface of the step-shaped ring groove.

In the above technical solution, the stability of pressing the jumping bead by the locking sheath can be ensured.

In some embodiments, the fixing part is a magnetic ring, a mounting ring groove is coaxially provided in the middle of an inner wall of the locking sheath, the magnetic ring is coaxially inserted and fixed in the mounting ring groove, the adjusting tube is made of magnetizable material, and the adjusting tube extends through the magnetic ring and abuts against an inner wall of the magnetic ring.

In the above technical solution, the magnetic ring fixed on the locking sheath is adsorbed to the adjusting tube to fix the locking sheath and the adjusting tube, which can further improve the convenience in adjusting the torque of the torque wrench.

In some embodiments, a connecting ring groove is coaxially provided in an outer wall of the adjusting tube, an inner side of the magnetic ring is inserted in the connecting ring groove, an inner wall of the magnetic ring abuts against a bottom wall of the connecting ring groove, and a width of the connecting ring groove is greater than a thickness of the magnetic ring.

In the above technical solution, two sides in a width direction of the connecting ring groove can provide a larger contact area for adsorption of the magnetic ring, which ensures the stability of the locking sheath on both sides in the width direction of the connecting ring groove.

In summary, the present application can achieve at least one of the following beneficial technical effects.

1. Adjusting the torque of the torque wrench can be facilitated by fixing the position of the locking sheath via the fixing part after being pushed or pulled.

2. Adjusting the torque of the torque wrench can be facilitated by the magnetic adsorption of the magnetic ring and the locking sheath which locks the position of the locking sheath via the fixing part after being pushed or pulled.

### BRIEF DESCRIPTION OF THE DRAWINGS

FIG. 1 is a sectional view of an overall structure of a magnetically locking mechanism of a torque wrench in Embodiment 1;

FIG. 2 is a sectional view of an overall structure of a magnetically locking mechanism of a torque wrench in Embodiment 2; and

FIG. 3 is a sectional view of an overall structure of a magnetically locking mechanism of a torque wrench in a related technology.

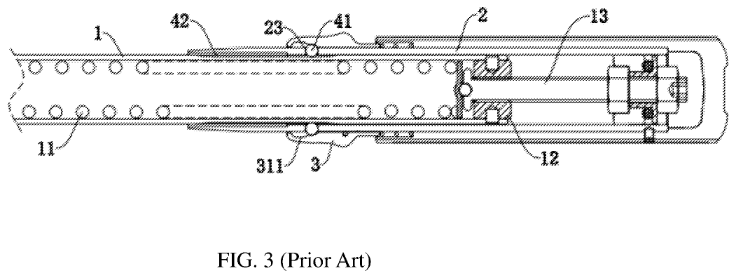

### DETAILED DESCRIPTION

The present application will be further described in detail below in combination with accompanying drawings.

In the related technology, a magnetizable material mainly includes iron, cobalt, nickel and so on. An object containing the magnetizable material can be adsorbed by a magnetic object such as a magnet, for example, a part or an object made of metals such as stainless steel or cast iron.

The present application provides a magnetically locking mechanism of a torque wrench.

### Embodiment 1

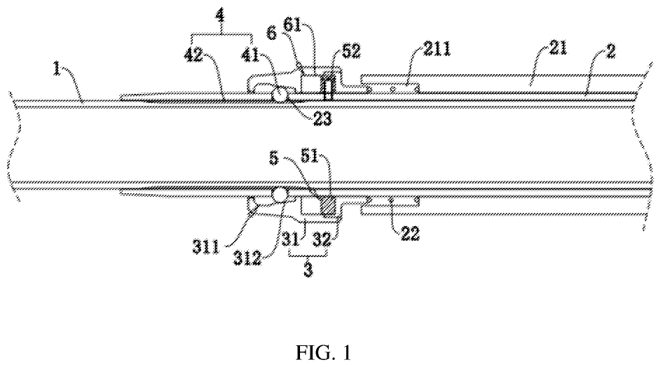

Referring to FIG. 1, the magnetically locking mechanism of the torque wrench includes a main tube 1 and an adjusting tube 2. One end of the adjusting tube 2 is coaxially sleeved onto a tail end of the main tube 1, and the other end of the adjusting tube 2 is fixedly connected to an adjusting screw 13. A locking sheath 3 is sleeved outside the adjusting tube 2 at an end close to a head end of the main tube 1, and both the locking sheath 3 and the adjusting tube 2 may be a magnetic part. In some embodiments, the locking sheath 3 and the adjusting tube 2 are made of stainless steel. A limiting structure 4 for limiting rotation of the adjusting tube 2 is arranged between the locking sheath 3, the adjusting tube 2 and the main tube 1. A fixing part 5 for fixing a position of the locking sheath 3 after sliding on the adjusting tube 2 is arranged between the locking sheath 3 and the adjusting tube 2.

Further, a handle 21 is sleeved onto the adjusting tube 2 at an end away from the head end of the main tube 1, and fixed on the adjusting tube 2 via a bolt. A step-shaped ring groove 211 is provided in an inner wall of the handle 21 close to one end of the main tube 1, and a compression spring 22 is arranged in the step-shaped ring groove 211 and coaxially sleeved onto the adjusting tube 2. One end close to the handle 21 of the locking sheath 3 enters the step-shaped ring groove 211. One end of the compression spring 22 abuts against a step surface of the step-shaped ring groove 211, and the other end abuts against an end of the locking sheath 3 enters the step-shaped ring groove 211. An inner wall of one end of the locking sheath 3 away from the handle 21 is formed with a cam surface 311, which is arranged around an axis of the locking sheath 3. The cam surface 311 includes two concave ring grooves 312, the two concave ring grooves 312 are arranged around the axis of the locking sheath 3 next to each other, and an concave ring groove 312 close to the handle 21 is shallower than the other concave ring groove 312 away from the handle 21, with a smooth transition inclining surface provided therebetween. The limiting structure 4 includes a jumping bead 41 and a long groove 42. The long groove 42 is formed in an outer wall of the main tube 1 along an axis of the main tube 1, and a plurality of the long grooves 42 are evenly formed along an axis of main tube 1. In some embodiments, there are eight long grooves 42. A hole 23 is opened in a side wall of the adjusting tube 2 at a position corresponding to the cam surface 311 The jumping bead 41 is inserted in the hole 23, with one side enters the long groove 42 and the other side contacting the cam surface 311.

When a bottom wall of a shallower concave ring groove 312 abuts against the jumping bead 41, the locking sheath 3 presses the jumping bead 41, and the jumping bead 41 is firmly pressed into the long groove 42, by which the jumping bead 41 and the long groove 42 limits the rotating of the adjusting tube 2, that is, the adjusting tube 2 cannot be rotated. When the locking sheath 3 is pulled toward the handle 21, a deeper concave ring groove 312 will let free the jumping bead 41 to provide a larger space for the jumping bead 41. In this way, when the adjusting tube 2 is rotated, the jumping bead 41 is pressed out of the long groove 42 with the help of its own arc surface, so that the jumping bead 41 does not hinder the rotation of the adjusting tube 2, that is, the adjusting tube 2 can be rotated to adjust the torque of the torque wrench.

Meanwhile, the locking sheath 3 includes a front ring section 31 and a rear ring section 32 positioned along the axis of locking sheath 3. The front ring section 31 is positioned at one side of the rear ring section 32 away from the handle 21, the cam surface 311 is formed on an inner wall of the front ring section 31, and one side of the rear ring section 32 close to the front ring section 31 is inserted in the front ring section 31 and threadedly connected with the front ring section 31. A reserving half-groove 61 is provided in the front ring section 31 and the rear ring section 32 at positions close to each other, respectively. The reserving half-groove 61 is a step groove arranged around an axis of the locking sheath 3. After the front ring section 31 and the rear ring section 32 are threadedly connected with each other, the two reserving half-grooves 61 combine to from a leg-free ring groove 6. The fixing part 5 is a magnetic ring 51, coaxially sleeved outside the adjusting tube 2, and positioned in the reserving ring groove 6. The thickness of the magnetic ring 51 along its axial direction is less than a width of the reserving ring groove 6.

In order to ensure the stability of the magnetic ring 51, the magnetic ring 51 is provided with a locking screw 52 from outside to inside, one end of which is screwed into the adjusting tube 2. A plurality of locking screws 52 are evenly arranged on the magnetic ring 51 at intervals around an axis of the magnetic ring 51. In some embodiments, there are three locking screws 52.

In some embodiments, the magnetic ring 51 is made of magnetic powder, supplemented with plastic or rubber, and has a high magnetism after magnetization. In some embodiments, the magnetic ring 51 includes two half rings, which combines to form the magnetic ring 51.

In other embodiments, the magnetic ring 51 can be made by uniformly providing NdFeB magnet on a plastic ring. Of course, the magnetic ring 51 can be made by attaching a magnetic ring to a side of the plastic ring.

When the bottom wall of the shallower concave ring groove 312 abuts against the jumping bead 41, the magnetic ring 51 is adsorbed onto a side of the reserving ring groove 6 close to the handle 21, so that the jumping bead 41 is stably pressed into the long groove 42 to reduce the possibility of being forced out of the long groove 42. When the locking sheath 3 is pulled toward one side of the handle 21, the deeper concave ring groove 312 lets free the jumping bead 41, and the magnetic ring 51 is adsorbed to a side of the reserving ring groove 6 away from the handle 21, so that the locking sheath 3 will not be pushed away by the compression spring 22. At this time, an operator can adjust the adjusting tube 2 in a long time.

To facilitate adjusting the torque of the torque wrench by the operator, an outer wall of one end of the adjusting tube 2 close to head of the main tube 1 is provided with scale lines around an axis of the adjusting tube 2, and an outer wall of the main tube 1 is provided with a reference line along an axis of the main tube 1.

In this embodiment, an implementation principle of the magnetically locking mechanism of the torque wrench is that: by magnetically locking the locking sheath 3 on the outer wall of the adjusting tube 2 via the magnetic ring 51, the locking sheath 3 can be stably kept in a position after being pulled or pushed. This helps reduce the possibility of the locking sheath 3 being automatically pushed toward the head end of the main tube 1 by the compression spring 22, and reduce the possibility of the locking sheath 3 being pressed by the jumping bead 41 and moved toward one side of the handle 21.

### Embodiment 2

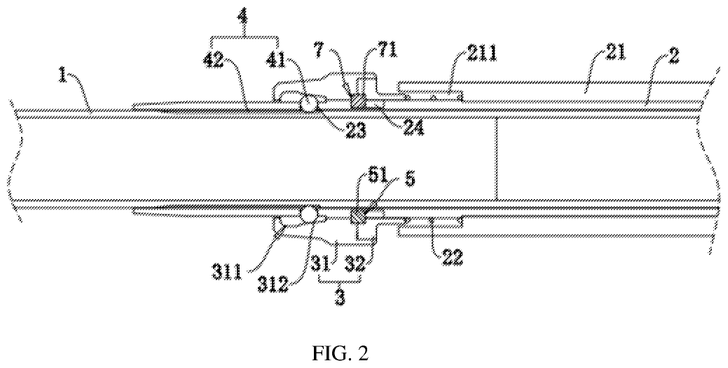

Referring to FIG. 2, the difference of this embodiment from Embodiment 1 is that, a mounting half-groove 71 is provided in the front ring section 31 and the rear ring section 32 at positions close to each other, respectively. The mounting half-groove 71 is a step groove provided around an axis of the locking sheath 3. After the front ring section 31 is threadedly connected with the rear ring section 32, the two mounting half-grooves 71 combine to form a mounting ring groove 7. The outer wall of the adjusting tube 2 is coaxially provided with a connecting ring groove 24, and the magnetic ring 51 is coaxially inserted and fixed in the mounting ring groove 7. An inner side of the magnetic ring 51 is inserted in the connecting ring groove 24, and a width of the connecting ring groove 24 along the axial direction of the main tube 1 is greater than a thickness of the magnetic ring 51.

When a bottom wall of the shallower concave ring groove 312 abuts against the jumping bead 41, the magnetic ring 51 is adsorbed onto a side of the reserving ring groove 6 away from the handle 21, so that the jumping bead 41 is stably pressed into the long groove 42 to reduce the possibility of the jumping bead 41 being forced out of the long groove 42. When the locking sheath 3 is pulled toward the handle 21, the deeper concave ring groove 312 lets free the jumping bead 41, and the magnetic ring 51 is adsorbed to a side of the connecting ring groove 24 close to the handle 21, so that the locking sheath 3 will not be pushed away by the compression spring 22. Thereby, an operator can adjust the adjusting tube 2 in a long time.

The above are the preferred embodiments of the present application, which are not intended to limit the protection scope of the present application. Therefore, all equivalent changes made according to the structure, shape and principle of the present application should be covered within the protection scope of the present application.

What is claimed is:

1. A magnetically locking mechanism of a torque wrench comprising a main tube and an adjusting tube, wherein one end of the adjusting tube is coaxially sleeved onto a tail end of the main tube, a second end of the adjusting tube is connected to an adjusting screw, a locking sheath is sleeved outside the adjusting tube at an end close to a head end of the main tube, an inner wall of one end of the locking sheath close to the head end of the main tube is formed with a cam surface, a hole is opened on the adjusting tube at a position corresponding to the cam surface, an outer wall of the main tube is provided with a plurality of grooves along an axis of the main tube, a jumping bead is inserted in the hole, with one side of the jumping bead abutting against a bottom wall of the grooves and a second side of the jumping bead abutting against the cam surface, and a fixing part for fixing a position of the locking sheath after sliding on the adjusting tube is arranged between the locking sheath and the adjusting tube.

2. The magnetically locking mechanism of the torque wrench according to claim 1, wherein the fixing part is a magnetic ring, the locking sheath is a magnetizable part, a reserving ring groove is coaxially provided in a middle of an inner wall of the locking sheath, the magnetic ring is coaxially fixed and sleeved onto the adjusting tube and positioned in the reserving ring groove, and a thickness of the magnetic ring along an axial direction of the magnetic ring is less than a width of the reserving ring groove.

3. The magnetically locking mechanism of the torque wrench according to claim 2, wherein the locking sheath comprises a front ring section and a rear ring section provided along an axis of the locking sheath, the cam surface is provided on an inner wall of the front ring section, the front ring section and the rear ring section are detachably and fixedly connected with each other, and a reserving half-groove is provided in ends of the front ring section and the rear ring section close to each other, respectively, and the reserving ring groove comprises two reserving half-grooves.

4. The magnetically locking mechanism of the torque wrench according to claim 2, wherein the magnetic ring is provided with a locking screw extending from outside to inside, and one end of the locking screw is screwed into the adjusting tube.

5. The magnetically locking mechanism of the torque wrench according to claim 2, wherein an outer wall of one end of the adjusting tube close to the head end of the main tube is provided with scale lines at intervals around an axis of the adjusting tube, and the outer wall of the main tube is provided with a reference line.

6. The magnetically locking mechanism of the torque wrench according to claim 2, wherein a handle is fixedly sleeved onto the adjusting tube at an end away from the head end of the main tube, a step-shaped ring groove is provided in an inner wall of the handle close to one end of the locking sheath, and a compression spring is provided between the locking sheath and a step surface of the step-shaped ring groove.

7. The magnetically locking mechanism of the torque wrench according to claim 1, wherein the fixing part is a magnetic ring, a mounting ring groove is coaxially provided in a middle of an inner wall of the locking sheath, the magnetic ring is coaxially inserted and fixed in the mounting ring groove, the adjusting tube is made of magnetizable material, and the adjusting tube extends through the magnetic ring and abuts against an inner wall of the magnetic ring.

8. The magnetically locking mechanism of the torque wrench according to claim 2, wherein a connecting ring groove is coaxially provided in an outer wall of the adjusting tube, an inner side of the magnetic ring is inserted in the connecting ring groove, an inner wall of the magnetic ring abuts against a bottom wall of the connecting ring groove, and a width of the connecting ring groove is greater than the thickness of the magnetic ring.
